(19) United States
(12) Patent Application Publication
(10) Pub. No.: US 2021/0092967 A1
(43) Pub. Date: Apr. 1, 2021

(54) METHOD OF FREEZING AND DEFORMING AN UNEVENLY SHAPED ELONGATED LOAF AND DEVICE SUITABLE THEREFOR

(71) Applicant: TVI ENTWICKLUNG & PRODUKTION GMBH, Irschenberg (DE)

(72) Inventor: Thomas VOELKL, Bruckmuehl (DE)

(73) Assignee: TVI ENTWICKLUNG & PRODUKTION GMBH, Irschenberg (DE)

(21) Appl. No.: 16/982,314

(22) PCT Filed: Mar. 12, 2019
(86) PCT No.: PCT/EP2019/056147

§ 371 Date: Dec. 7, 2020

(30) Foreign Application Priority Data
Mar. 19, 2018 (DE) 10 2018 106 299.0

(51) Int. Cl. A22C 7/00; F25D 31/00

(52) U.S. Cl. CPC A22C 7/0023; A22C 17/002; F25D 31/00

(57) ABSTRACT

In order to be able to insert loafs, which are pre-frozen for slicing into slices, at least lightly frozen, into a form cavity of a form tube without any problems or to manage with smaller form tube cross-sections, it is proposed, according to the disclosure, to carry out the first part of the forming of the loaf already before freezing, i.e., when inserting it into a preform. The loaf is frozen in this state, compressed in the preform, together with the preform in a freezer, then removed and fed to the final pressing in the form tube to the final pressed state.

### CROSS-REFERENCE TO RELATED APPLICATION

This application is the U.S. national phase of PCT Application No. PCT/EP2019/056147 filed on Mar. 12, 2019, which claims priority to German Patent Application No. DE 10 2018 106 299.0 filed on Mar. 19, 2018, the disclosures of which are incorporated in their entirety by reference herein.

### TECHNICAL FIELD

The invention relates to the pre-treatment of loaf-shaped, irregularly shaped food-stuffs, in particular loafs of meat, prior to slicing into slices, in particular exact weight slices.

### BACKGROUND

A food loaf of this kind with an irregular cross-section over its length is, for example, a meat loaf, i.e. a grown piece of meat which, although it has approximately the same shape depending on its origin and the same point of origin on the animal, the differences from one meat loaf to another are nevertheless considerable.

In the following, only a loaf is mentioned, without limiting the invention to a meat loaf. In addition, the invention is of course also applicable, for example, to loaf-shaped parts of a fish or other irregular loafs which are not foodstuffs.

With regard to the cross section of uniformly shaped food strands, so-called calibres, as they can be produced from a homogeneous foodstuff such as sausage or cheese, these problems do not usually arise or only to a much lesser extent.

However, several methods are known to be able to cut weight-accurate slices from an irregular loaf of meat, the cross-section of which may, for example, decrease from one end to the other, or which may be pear-shaped or barrel-shaped, or even spindle-shaped:

Either the contour of the meat loaf is measured before slicing, so that the cross-sectional shape and size is known at each of its longitudinal positions—the greatest direction of extension of the meat loaf is defined as the longitudinal direction—and the weight of the slice to be cut can be controlled accordingly by determining the thickness of the slice, since the specific weight of the respective meat loaf is generally known with sufficient accuracy for this purpose.

Another method is to give the meat loaf a defined cross-section before and during slicing by deformation, especially over the entire length of the meat loaf.

Before being pressed and immediately sliced, the meat loaf is usually frozen, i.e. cooled to below room temperature, and in particular, at least on the outside, even frozen, which makes it easier to produce clean edges when slicing.

For this purpose, the meat loaf is placed in a so-called forming tube and pressed in it in the longitudinal and/or transverse direction so that it completely fills the hollow space of the form, i.e. has its constant cross-section over its entire length.

The meat loaf pressed in this way is pushed out of the face side, open end of the forming tube by the desired slice thickness in each case and a slice with a pre-calculated thickness and thus a weight very close to the set weight is cut off directly at the end of the forming tube.

Since the dimensions of the meat loafs can vary greatly, the free internal cross-section of the forming tube must be relatively large, at least in the initial state in which the meat loaf is inserted into the forming tube, and the meat loaf must then be deformed relatively strongly.

However, an upper limit of the forming process should not be exceeded in order not to change or even damage the internal structure of the grown piece of meat.

### SUMMARY

It is therefore the object of the present invention to provide a process and a device which improves the deformation of the loafs and makes it more gentle.

As far as the process is concerned, this object is solved by deforming the loaf before freezing in order to equalize the cross-section over the length of the loaf as much as possible by reducing the cross-section especially in those length areas of the loaf where its cross-section is significantly larger than in the other length areas, thereby making the shape of the loaf more uniform with regard to the cross-section.

In addition or instead, the loaf can be compressed in the longitudinal direction, whereby the areas with a smaller cross-section also make a cross-sectional expansion.

In this way, the deformation work required to achieve a cross-section that is uniform throughout its length is divided between the two steps of preforming before freezing and final pressing after freezing. On the one hand, this is gentler on the loaf to be deformed, allows less movement of the moving elements of the required devices and considerably reduces the force required for final pressing.

Pre-forming before freezing is generally carried out by means of a preform into which the loaf is placed and in which it is in a pre-formed state, compressed at least in some areas, and in which it remains during freezing.

Accordingly, the preform must be made of a material which is not damaged by pre-freezing and which nevertheless allows easy removal of the frozen loaf from the preform after freezing.

Furthermore, the form should be made of a material that has good thermal conductivity, for example a metal such as stainless steel or aluminium, and/or good temperature storage capacity. Plastic can also be considered, especially because of the low static friction against the loaf in the frozen state.

Preferably the preform can be brought to a lower temperature than that of the loaf before it is inserted, in particular a temperature no higher than 10 C above the temperature in the freezer room, where the loaf is then frozen in order to quickly extract heat from the loaf after insertion and close its outer pores, thereby rapidly ending liquid loss through evaporation.

In order to speed up the cooling down of the preform in the freezer, when a preform is used, it may also have a design with a large outer surface on its outer sides, in particular cooling fins.

Typically, the loaf either has a large cross-section at one end, which decreases towards the other end, usually continuously, or the loaf has its largest cross-section in the medium length range.

Therefore, during preforming, at least the length part of the loaf, where it has its largest cross-section, in particular its largest diameter, is compressed by the preform and held in this compressed state. For this purpose, the loaf is preferably placed in the preform rotated about its longitudinal direction in such a rotational position that it is compressed by the preform in the transverse direction in which it has its greatest diameter.

By eliminating or reducing this largest diameter, and thus usually also the largest cross-section, an essential step has already been taken on the way to a cross-section that is the same over its length.

Preforming before freezing can in principle be done in two ways, which can also be combined:

The first possibility is to press the loaf into a preform with fixed dimensions in a certain direction and cause the preforming of the loaf by this pressing.

The reduction of the largest diameter can thus be carried out in such a way that the preform has a smaller, in particular fixed, width, for example between two side walls, in particular parallel to each other, than this largest diameter, and the loaf is pressed into the preform with the transverse direction of its largest diameter lying in the direction of this width.

This means that after insertion the loaf already has a largest diameter, in particular also a largest cross-section, which is smaller than in the initial state, but usually even larger than the desired, consistently identical final cross-section.

As a result of the static friction between the loaf at the point of its largest diameter, compressed in the transverse direction, and the preform, the latter is also fixed in its longitudinal position, so that in addition compression of the loaf in the longitudinal direction over at least half of its length can also be achieved by pressing one of its ends against an end face of the interior of the preform before the loaf is pressed into the preform and compressing it slightly, and in this state, in which it is kept compressed, only the loaf with the region of the largest cross-section is pressed into the preform.

The pressing in can be done manually or with the help of a manually or motor driven device.

The other possibility is to place the loaf in a preform cavity of such a size that it is not yet necessary to compress the loaf in order to insert it, and only then to compress the loaf by one or more moving parts of the preform and bringing them closer to the rest of the preform, and to keep the compressed loaf in this state even during freezing by fixing the moving parts relative to the rest of the preform.

These operations can be carried out in the longitudinal direction—the main direction of extension of the preform cavity—and/or in one or both of the transverse directions to the longitudinal direction.

While in the simplest case the preform consists of only two side walls, connected by a fixed end wall and a second end wall, either fixed or movable in the longitudinal direction as described, a preform with a bottom is usually preferred which also connects the two side walls.

A lid may be placed on such a trough-shaped preform, which is pressed against the loaf from the open side of the preform and also compresses the existing maximum width of the loaf in this transverse direction.

The lid can be attached to the preform in a movable, e.g. pivotable, manner, or it can be pressed as a separate part against the rest of the preform and fixed, preferably locked, in this compressing position.

This means that in the device for final pressing required after pre-freezing, for example the form tube, smaller form tube inner cross-sections can be provided and/or the frosted loafs can be inserted into the form tube with all loafs, and it is no longer the case that a loaf has an area of too great thickness and cannot be fully inserted into the form tube.

The preform—in which a loaf or several loaves are placed side by side and kept in a compressed state in this way—is frozen by placing it in the freezer, i.e. in particular either on the conveyor belt of a belt freezer or by hooking its lateral ends into the transport chains of a chain freezer.

After leaving the freezer, i.e. the freezer room, the loafs are removed from the preforms again, for which purpose any individual parts of the preform that are movable relative to each other must be moved back from the state compressing the loaf, i.e. any attached fixings or latches of these parts relative to each other must be released.

Preferably, removal from the preform is carried out automatically with the aid of a removal device arranged in the passing direction through the freezer after the freezer room, i.e. outside the freezer room.

This is possible because this removal device can be adjusted to the same shape and outer contour of the preform regardless of the current shape of the loaf.

The loafs preformed and frozen in this way can now be easily end pressed to a final cross section with relatively small further deformation distances.

This is preferably done in a circumferentially closed form tube with open ends and a tubular form tube cavity. The cross-section of this form tube cavity can now be reduced, as the preformed loafs have a smaller maximum diameter and cross-section than in the initial state.

In this forming tube cavity, the preformed loafs are further end pressed in the longitudinal direction and/or at least one of the two transverse directions into the final state and onto an end cross section.

As far as the device is concerned, this object is solved by a device with a preform that is suitable for receiving at least one loaf and suitable for being frozen together with the loaf received therein.

Where appropriate, the device also includes a freezer for freezing the preforms with the loafs contained therein.

The preform is additionally designed in such a way that the loaf received in it is preformed in the direction of the end cross-section, i.e. its initial cross-section is already reduced and varies less over the length than in the initial state, but does not yet have a uniform cross-section, the end cross-section, over the entire length.

This is achieved by ensuring that the preform cavity, in particular the variable preform cavity, has a width, particularly in its minimum transverse dimension, less than a predetermined limit, which corresponds in particular to the minimum maximum diameter of most of the loafs to be accommodated therein, i.e. at least 95% of the loafs to be accommodated therein, in their initial state.

For this purpose, the preform has two side walls running at a distance from each other in the longitudinal direction, the distance between them in the first transverse direction being less in at least one longitudinal area than the greatest thickness of most of the loaves to be inserted between them. The side walls preferably run parallel to one another and are therefore at the same distance from one another everywhere.

The distance between the side walls may also be adjustable, in particular one of the two side walls, which are movable relative to each other, may be used to compress the loaf inserted between them.

Preferably, however, the two side walls are located at a fixed distance from each other and are preferably also connected to each other at at least one of their ends by a fixed end wall.

Preferably, the preform between the side walls has a bottom that connects the two side walls in particular,

and/or
between the side walls, at least one fixed end wall connecting the one ends of the side walls pointing in the longitudinal direction, preferably also a fixed end wall (1e) connecting the other ends of the side walls whereby a preform trough (1.1) can be formed.

A movable end wall is designed as a longitudinal side, preferably movable in the longitudinal direction relative to the side walls and in particular between the two fixed partitions, and can be displaced in the longitudinal direction between the side walls and/or can be latched to latching elements present at several longitudinal positions, which are preferably located on the outside of the preform, after this movable end wall has first been pressed against one end face of the loaf and the latter has been compressed.

Compression may be effected by placing at least one pressure spring between the longitudinal slide and the adjacent fixed end wall, which maintains a continuous longitudinal pressure on the loaf.

However, this pressure in the longitudinal direction can also be achieved by placing the longitudinal slide at the front end of a sliding bar which runs in the longitudinal direction and extends in particular through the fixed end wall of the preform trough.

The pressure is preferably applied manually to the rear end of the push rod and is maintained by locking the push rod against the rest of the preform, in particular against the fixed end wall, in the advanced working position compressing the loaf.

This can be achieved, for example, by means of several notch elements in longitudinal direction one behind the other on the sliding rod in only a part of the circumference, so that depending on the rotational position, an engagement with a counter element, which is also only present in one area of the circumference at the passage opening through the fixed end wall, is achieved. The sliding rod can thus be locked or unlocked by turning it through less than 360, for example only 90 about its longitudinal axis.

Another possibility is a self-locking thread in the passage opening through the fixed end wall, which meshes with a thread on the outer circumference of the sliding rod, whereby a connection rotatable about the longitudinal axis is required between the longitudinal slide and the sliding rod.

If the preform has only side and end walls, it would merely form a frame which rests on the bottom and in which the loaf is clamped, which makes it easier to remove it, since after freezing the loaf only has to be pressed out of the preform again in the open transverse direction.

Above all, however, in order to be able to preform the loaf also in the second transverse direction, i.e. transversely to the direction of the distance between the side walls, the preform preferably has a bottom which connects the lower ends of the side walls and/or end walls to one another, so that the preform is trough-shaped and can be closed by a lid which is pressed onto the open side and can be locked if necessary, whereby an inserted loaf can also be compressed, i.e. preformed, in this second transverse direction and held in this state.

The lid and/or the bottom may be attached to the rest of the preform in such a way as to be movable between a closed and an open position, or may be completely detachable from the rest of the preform in a simple and quick manner, in particular without the use of tools.

In particular, the lid can be fixed, and in particular latched, in several positions which are approached to the rest of the preform to varying degrees.

There are two basic embodiments of the lid:

In a first embodiment, the usually plate-shaped lid has a stamp appendix protruding transversely to its main plane, the area of which, when viewed from above, corresponds approximately to the opening of the preform cavity, so that it dips into this opening when the lid rests on the edges of the side walls.

In order to exert pressure on the loaf, one or more pressure springs can be arranged, for example, between the stamp appendix and the plate-shaped lid, so that the stamp appendix lying against the loaf exerts the desired pressure.

Instead or in addition, the lid can be locked in this transverse direction in one of several approach positions, i.e. with the stamp appendix dipping in to different depths, on corresponding catch elements of the side walls or end walls, preferably pressed against the loaf manually by the operator. The lid does not have to reach the upper edges of the side walls.

In this design, the distance from the base or bottom to the underside of the stamp appendix varies according to the cross-section of the loaf, so that the longitudinal slide, which should preferably enter under the stamp appendix, should have a variable extension in this transverse direction, i.e. a variable cross-section.

The longitudinal slide therefore preferably consists of two parts which complement each other in this transverse direction to the longitudinal slide and which are pretensioned against each other, especially in the direction away from each other, for example by means of a spring.

In another embodiment, the lid in the working position does not protrude into the preform cavity, but is only located on or above the upper edges of the side walls.

This lid can also be fixed at several height levels relative to the opening, i.e. to the upper edges of the side walls, in relation to the rest of the preform. Any remaining gap between such a lid, which is at most in contact with the upper edges of the side walls, can be used to push material of the loaf out of this gap, but this can be avoided by applying a limited pressure force to the lid.

Instead, the lid can also be fixed at a single height, for example resting on the upper edges of the side walls, opposite the rest of the preform, for example by pushing it over the opening in appropriate longitudinal guides.

The loaf in the preform must either be pushed down manually by the operator of this sliding lid during the closing process, or the loaf has such a small cross-section that it cannot reach it anyway.

The advantage of this solution is that the longitudinal slide can be fixed at one end of such a lid-only lid, in particular a sliding lid, so that essentially only longitudinal compression is exerted on the loaf, but the cross-section of the loaf is increased so that it reaches the underside of the closed lid and is pressed against it, even if it did not reach this height in the initial state.

The preferably existing bottom of the preform can be inserted as a sliding bottom along the lower ends of the side walls and thereby close the preform cavity downwards, or it can be fastened to the lower ends of the side walls by means of other fastening elements, in particular retaining clips.

The bottom may also be permanently attached to the lower ends of the side walls, but then preferably has at least one ejector opening penetrating the bottom, through which the frozen loaf can be pressed out of the top-opened preform by means of an ejector after freezing, in particular by means of a removal device.

Such an ejector opening can also be relatively large, so that the bottom only forms a frame. Especially in this case, the large-area ejector opening can be closed by an ejector plate, which is placed on the bottom from above and rests on the edges of the bottom around the ejector opening.

To remove the frosted loaf, the ejector plate can be moved into the interior of the preform cavity by means of a tool, especially when the preform is upside down, thus removing the frosted loaf from the preform.

The freezer may have, in the passing direction after its outlet opening, i.e. outside the freezer room, a device for removing the loaves from the preforms which is not automatic, in particular which operates as described above, and which may in particular operate automatically.

If it is desired that the preforms are already pre-cooled when the strands are inserted, the freezer should have as part of its freezer room a buffer room, in particular a storage room for empty preforms, in which the preforms are kept at the desired reduced temperature.

Since the heat transfer from a solid material to the loaf is greater than that from air to the loaf, the temperature of the inserted loaf will drop more quickly with a pre-cooled form than with a loaf inserted into the freezer without a pre-form.

Preferably, the device also includes the pressing device for final pressing of the frozen and preformed loafs to a final cross-section that remains constant over the length.

Preferably, this pressing device comprises a form tube with a form tube cavity open at each end face, the form tube having a longitudinal press stamp which is movable in the form tube cavity in the longitudinal direction for longitudinal pressing, and a transverse press stamp which is part of the wall around the form tube cavity.

Types of execution according to the invention are described in more detail below as examples, with reference to the below drawings.

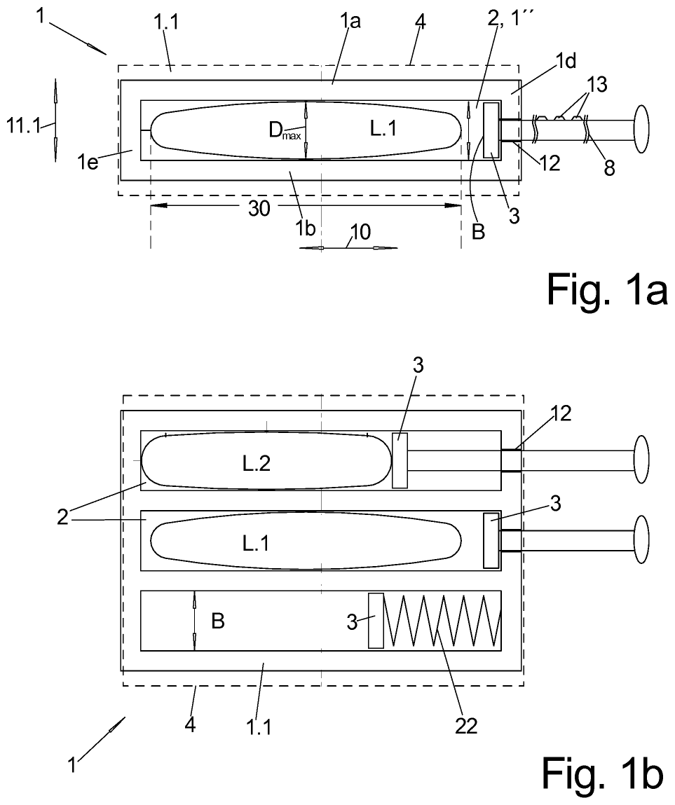

FIG. 1a: a preform with only one preform cavity in the top view,

FIG. 1b: a preform with three adjacent preform cavities in plan view,

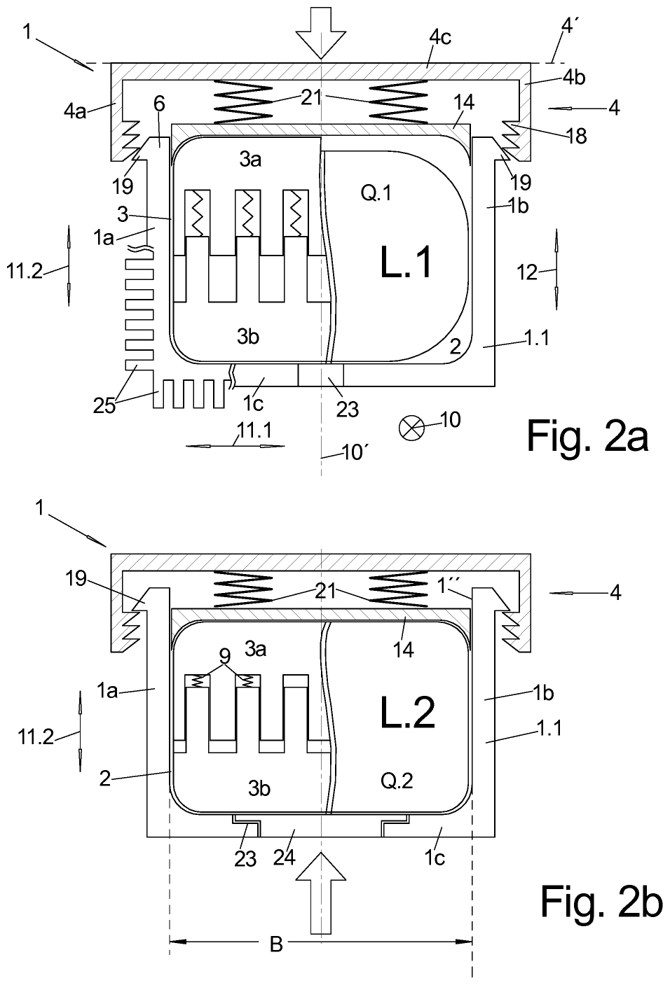

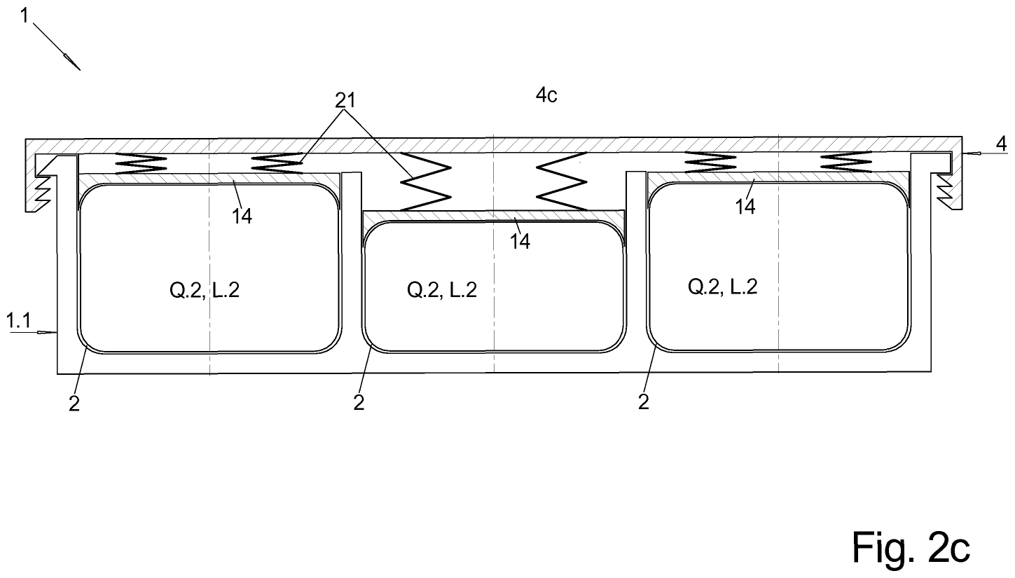

FIG. 2a: a preform in cross section with a loosely fitted lid that has a stamp appendix,

FIG. 2b: the preform of FIG. 2a with latched lid,

FIG. 2c: a cross-section through a preform with three preform cavities as shown in FIG. 1b,

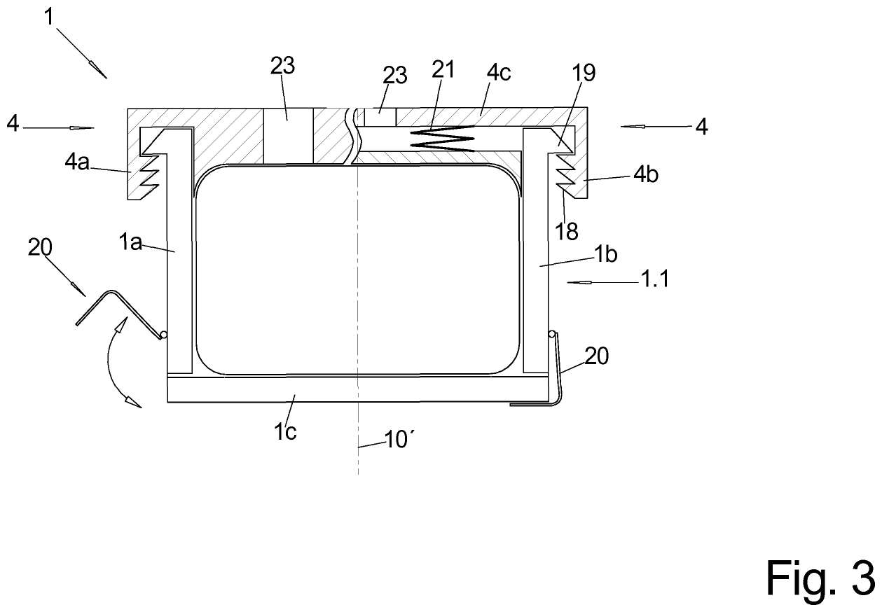

FIG. 3: a preform with a detachable bottom in cross-section,

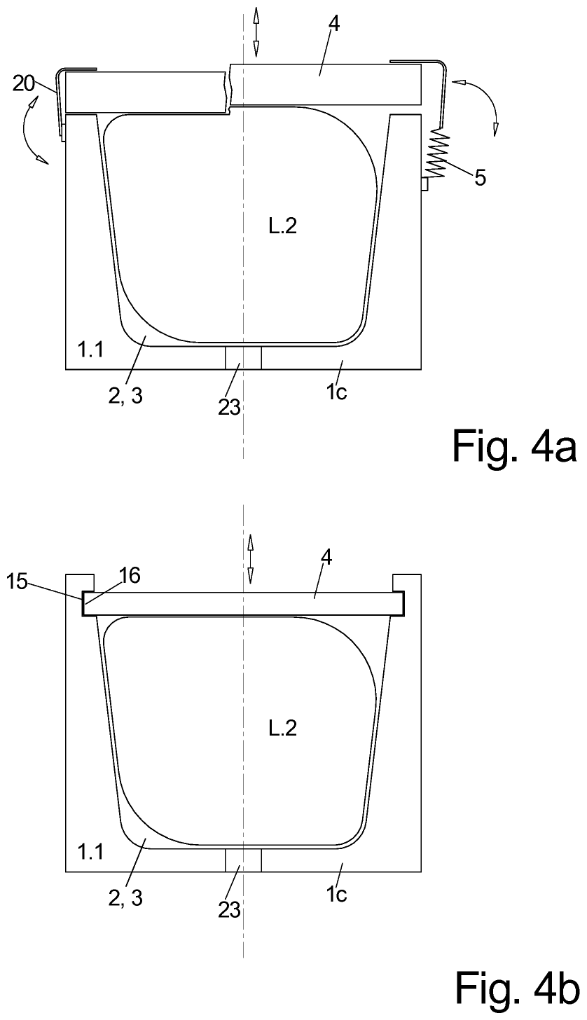

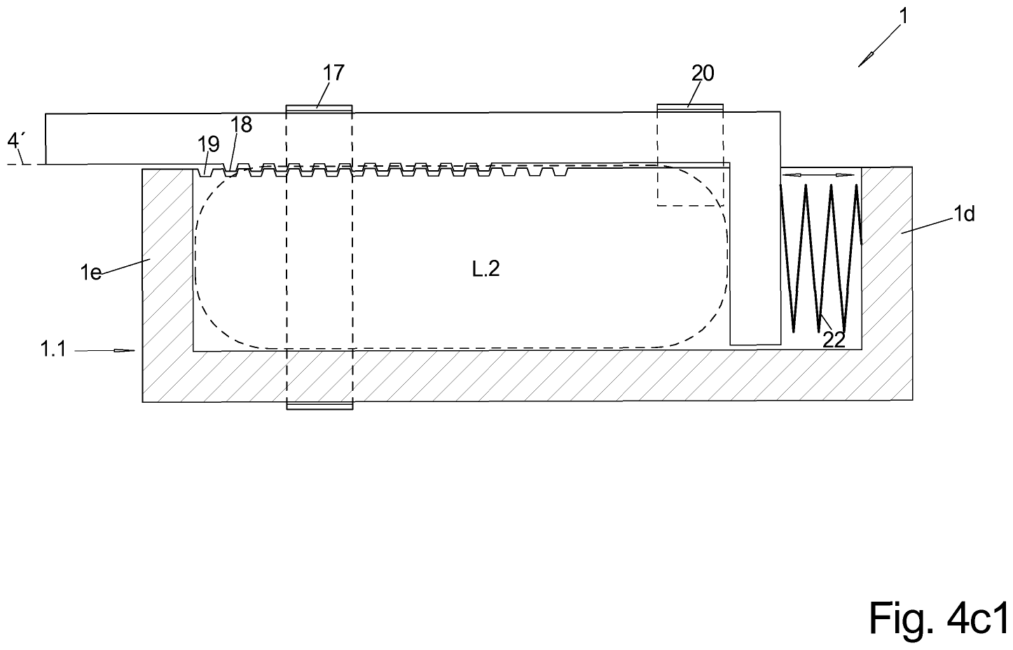

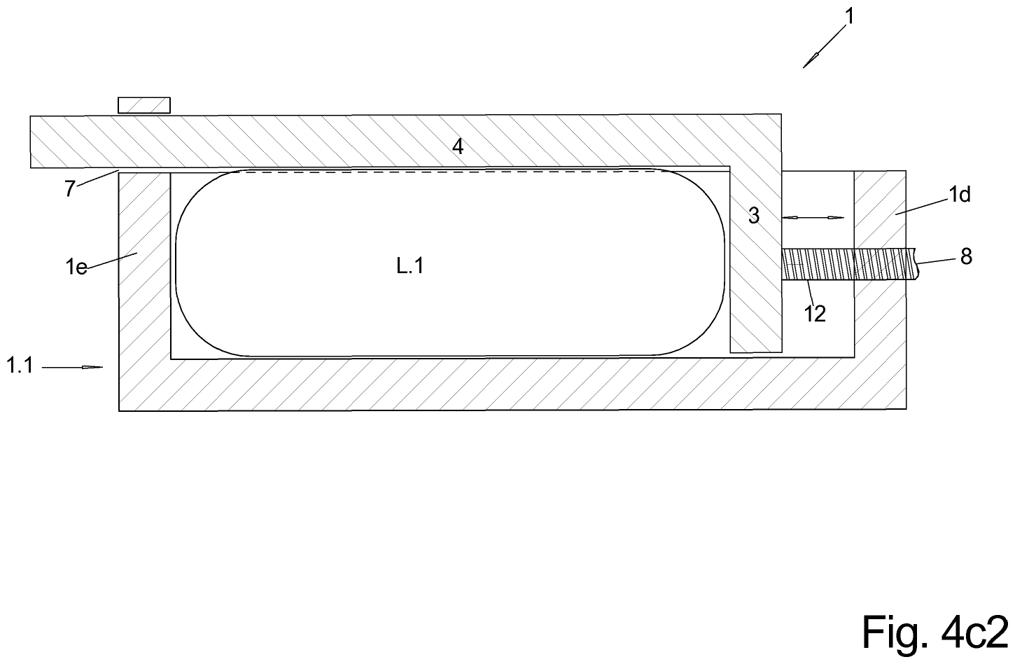

FIG. 4a: a cross-section of a design with a slide-in lid,

FIG. 4b: a longitudinal section through a design with a clampable lid without stamp appendix,

FIG. 4c: a longitudinal section through another preform design,

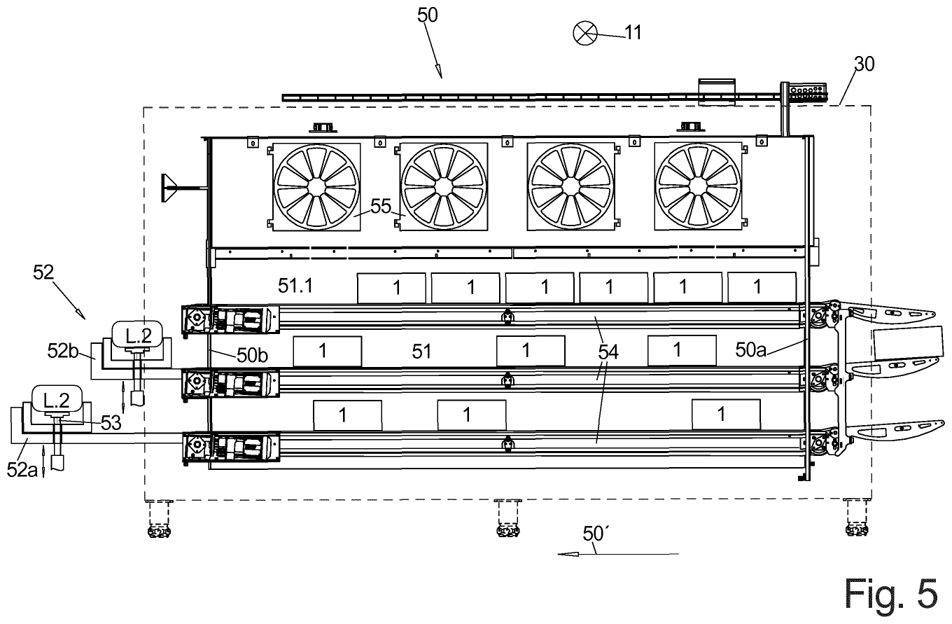

FIG. 5: a belt freezer with removal device in side view,

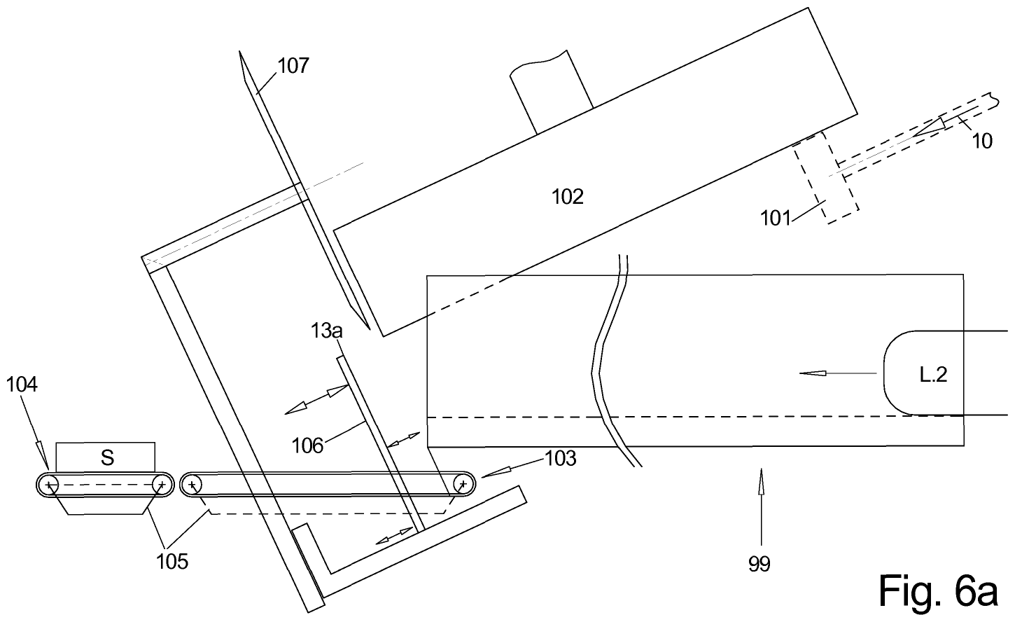

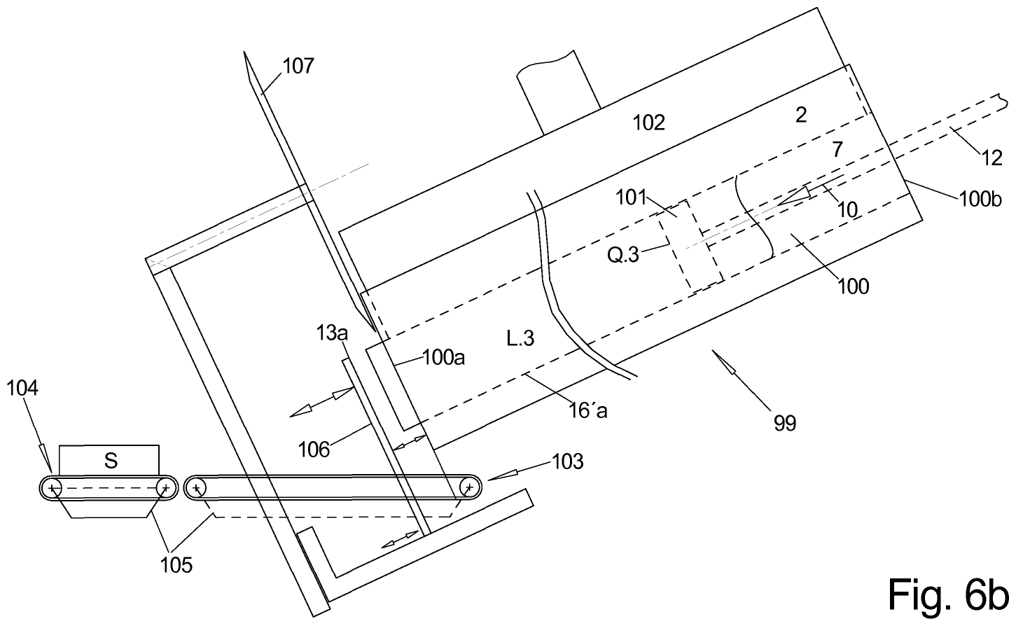

FIG. 6a, b: a form tube with longitudinal press stamp and transverse press stamp in side view in different functional positions.

### DETAILED DESCRIPTION

FIG. 1a shows a preform trough 1.1 in top view with a view of the opening 1″ of the form tube cavity 2, which can be closed to a preform 1 by placing a lid 4 (only indicated) on top, as better shown in the cross-sectional views of FIGS. 2a, b.

FIG. 1a also shows the longitudinal slide 3, which is parallel to one of the side walls 1a, b, and is in the form of a movable end wall 3, which in this case is located at the front end of a sliding rod 8 which extends rearwards through the fixed end wall 1d of the preform trough 1.1 and by means of which the longitudinal slide 3 can be subjected to force in the longitudinal direction:

This is done either by screwing as shown by means of a self-locking thread 12 opposite the passage opening of the fixed end wall 1d, or by notch elements 13, which are arranged several times one behind the other in the longitudinal direction 10 on the push rod 8, but only over part of its circumference, and analogously at least one counter element is arranged on or in the passage opening through the fixed end wall 1d.

Then the push rod 8 can be pushed forwards in the longitudinal direction 10 and locked by turning it through a certain angle relative to the counter element and the end wall 1d.

A loaf L in FIG. 1a is still in the initial state L1 and was also not yet compressed in the first transverse direction 11.1, the width B, i.e. the direction of the distance between the side walls 1a, b of the preform cavity 2, by insertion into this preform cavity 2, since its maximum thickness Dmax was equal to or slightly less than the width B, and its length 30 was less than the free length in preform 1 with the longitudinal slide 3 retracted to the fixed end wall 1d.

FIGS. 2a, b show a cross-section of a preform 1 consisting of a preform trough 1.1 and a lid 4, which consists of two parts, one of which is the preform trough 1.1 and a lid plate 4c which spans the preform cavity 2, and a usually plate-shaped stamp appendix 14 which is arranged on the underside of and at a distance from this lid plate 4c and which projects transversely to the main plane 4′ of the lid plate 4c into the preform cavity 2 and whose dimensions in plan view are such that it fits tightly into the opening 1″ of the preform cavity 1.1.

The stamp appendix 14 is held at a variable, load-dependent distance from the lid plate 4c by means of pressure springs 21 arranged in between.

For fixing the lid 4 to the preform trough 1.1, limbs 4a, b project downwards, viewed in the longitudinal direction 10, from the lateral ends of the lid plate 4c, which each have in their lower end region at least one detent element 18 pointing towards the longitudinal median plane 10′, which can catch under a counter element 19 projecting outwards from the upper region of the side walls 1a, b, preferably in the form of a edge strip 6 extending in the longitudinal direction 10.

In addition, several from either the notch elements 18 and/or the counter elements 19 can be provided at a distance in the height, i.e. the depth direction of the preform trough 1.1, the second transverse direction 11.2, in order to be able to lock the lid plate 4c at several height levels relative to the preform trough 1.1.

FIG. 2a shows a preform 1, into which a loaf L.1 with its cross-section Q.1, which it has in its initial state, has already been inserted.

The lid 4 is only loosely placed, so that its stamp appendix 14 already projects slightly into the opening 1″ of the form tube trough 1.1, but does not quite reach the loaf L.1.

In FIG. 2b, by pressing on the lid plate 4c from above, the notch elements 18 are pushed downwards past the counter elements 19 and locked against them, so that the stamp appendix 14 now plunges deeper into the interior of the preform trough 1.1 and its parallel inner sides of the side walls 1a, b. In doing so, it compresses the loaf in the 2nd transverse direction 11.2 and deforms it to a cross-section Q.2, which in most areas of the length of the loaf in state L.2 fills the free inner cross-section—which is rectangular here with rounded corners—between the preform trough 1.1 and the stamp appendix 14.

As the longitudinal slide 3 should be able to enter 10 in the longitudinal direction under the stamp appendix 14, as shown in FIG. 1a, it is 11 in the 2nd transverse direction.2 is constructed in two parts, whereby the two slide parts 3a, b intermesh alternately with fingers or tines, and—for example, pressure springs 9 arranged between the free ends of the tines and the corresponding recess in the other slide part—are pressed apart so that the contact surface of the longitudinal slide 3 visible in FIGS. 2a, b essentially always lids the entire free cross-section in the preform 1.1, which is why the longitudinal slide 3 also has analogously rounded corners and again has an inner free cross-section of preform 1.

FIG. 2a also shows the possibility of arranging cooling fins 25 on the outside of the side walls 1a, b and/or bottom 1c to increase the surface area and improve heat dissipation of the preform 1. In this case, the wall thickness of the side walls 1a, b and/or bottom 1c is shown here very thin if they are made of stainless steel, for example, but this does not necessarily depend on the arrangement of cooling fins 25.

The wall thickness of preform 1 is only increased above the level required for the necessary stability if a high heat capacity of preform 1 is to be achieved.

In order to facilitate the removal of the loaf L.2 from the preform 1.1 after freezing, FIG. 2a only provides for an ejector opening 23 in the bottom 1c of the preform tray 1.1, which remains open even during freezing, since it is relatively small in area, and through which the loaf L.2 can be ejected from below from the preform tray 1.1, which is then open at the top, by means of an ejector not shown.

FIG. 2b shows a solution in which this ejector opening 23 is chosen to be much larger, encompassing almost the entire surface of the bottom 1c, but is closed by an ejector plate 24 which can only be inserted from above, i.e. from the preform cavity 2, and rests on a shoulder of the circumference of the ejector opening 23, with the upper side of the ejector plate 24 being flush with the upper side of the surrounding, often only frame-shaped, bottom 1c.

To eject a loaf L.2 after freezing, the ejector plate 24 is pressed from below into the preform trough 1.1 which is open at the top, thus pushing the frozen loaf L.2 upwards.

FIG. 1b shows a preform 1 consisting of a preform trough 1.1 with three adjacent preform cavities 2 separated from each other by fixed partitions, the side walls 1a, b and the partitions running parallel to each other, i.e. the preform cavities 2 occupying a fixed distance B from each other which is constant over the longitudinal direction 10.

In the middle cavity 2, the longitudinal slide 3 has not yet been pushed forward against the loaf L still in the initial state L.1, whereas in the upper preform cavity 2 in FIG. 1b this has already occurred, so that the loaf L is already in the deformed state L.2 when the longitudinal slide 3 is subjected to force, and in particular when the only indicated lid 4, which extends over the entire form tube trough, is already braced against the form tube trough 1.1.

FIG. 1b shows in the lower preform cavity 2 that the force acting on the longitudinal slide 3 in the longitudinal direction 10 is not applied by means of the sliding rod 8 but by means of a pressure spring 22, which is arranged between the longitudinal slide 3 and the adjacent fixed end wall 1d.

To insert a loaf L, the operator must therefore first push back the longitudinal slide 3 against the force of this pressure spring 22 so far that the loaf L to be inserted fits into the remaining space between the pushed back longitudinal slide 3 and the opposite fixed front wall 1e. As soon as the operator then releases the longitudinal slide 3, the inserted loaf L.1 is compressed in the longitudinal direction 10 by the force of pressure spring 2.

FIG. 2c shows a cross-section of the corresponding preform 1 with the associated lid 4:

The lid plate 4c spans the entire preform trough 1.1 over all three preform cavities 2 and on its underside three separate stamp appendices 14 are again attached by means of pressure springs 21, each of which penetrates into one of the cavities 2, but with the lid plate 4c fitted and locked in place, the depth of penetration varies according to the cross-section Q.2 of the loaf in the deformed state L.2.

In contrast to FIGS. 2a, b, in FIG. 3, the bottom 1c of the preform trough 1.1 is detachable—i.e. easily and quickly removable without tools—attached to the lower ends of the side walls 1a, b, by means of retaining elements such as retaining clips 20, which in this case are pivotally attached to the outside of the side walls 1a, b and can be pivoted with their free end under the bottom 1c.

This gives the possibility to remove the frozen loaf L.2 also downwards from the preform 1 after removing the bottom 1c, for example by providing an ejector opening 23 in the lid 4 or after also removing the lid 4.

FIG. 3 also shows that the lid 4 together with the stamp appendix 14 can be formed in one piece, so that the pressure on the loaf L.2 located therein is only provided by the pressure applied once during locking.

Whereas in the case of a separate stamp appendix 14, the ejector opening 23 penetrates only the lid plate 4c, and a tool can be used to press against the upper side of the stamp appendix 14, which then ejects the loaf L.2 downwards—provided the springs 21 are sufficiently long for this purpose—in the case of a one-piece design of the lid 4 as shown in the left half, the ejector opening 23 naturally penetrates the entire lid 4, in both cases preferably centrally and not as shown off the longitudinal central plane 10′.

FIG. 4a shows a cross-sectional view of a solution in which the lid 4 does not dip into the preform cavity 2, but rests at most on the upper edges of the side walls 1a, b of the preform trough 1.1.

The height of the side walls 1a, b of preform 1 from the bottom 1c fixed to the side walls 1a, b is such that most of the loafs L in the initial state L.1 protrude upwards beyond the upper edges of the side walls 1a, b, and are only pressed down by the lid 4 and deformed to a cross-section Q.2, which is approximated to the free cross-section of the preform cavity 2, as shown in FIG. 4a and also FIG. 4b, by bringing the lid 4 closer to or close to the upper edges of the side walls 1a, b.

The lid 4 can be clamped down by means of suitable holding elements such as retaining clips 20, which press the lid 4 against the upper ends of the side walls 1a, b as shown in the left half, or preferably even allow a distance of the lid 4 relative to the upper ends of the side walls 1a, b, due to the retaining elements such as retaining clips 20, which are shown on the right, for example equipped with tension springs 5.

The advantage of the lid 4, which only rests on top, is that here the inner surfaces of the side walls 1a, b do not have to run parallel to each other, but their distance may increase upwards, so that the frosted loaf L.2 can later be removed more easily from the preform tub 1.1 upwards, for example again by means of the ejector opening 23 in the bottom 1c shown.

FIG. 4b shows a solution analogous to FIG. 4a, but deviating from this, the lid 4 can be inserted along longitudinal guides 15, which in this case are formed in the upper area in the inner sides of the side walls 1a, b, with the aid of a guide part 16 running therein, in this case the narrow sides of the lid 4 running in the longitudinal direction 10.

A loaf L, which in the initial state L.1 projects upwards over the underside of lid 4, is pushed down manually when lid 4 is pushed in so far that lid 4 can be pushed further forwards.

The advantage of this solution is that the free cross-section available for the loaf in the form tube trough 1.1 is always the same size, i.e. it reaches up to the upper edge of the side walls 1a, b, and therefore a longitudinal slide 3 can also have a corresponding fixed shape and size and can therefore be produced in one piece.

This fact also makes it possible that, according to FIGS. 4c1, 4c2, the longitudinal slide 3 can be attached to one longitudinal end of the only resting, non-immerging lid 4, i.e. it can protrude downwards from the main plane 4′ of the plate-shaped lid 4 and close the cross-section of the preform cavity 2.

This combined longitudinal slide and lid 3+4 can either be pressed manually against the loaf Las shown in FIGS. 4c1, 4c2 after insertion of the loaf L in the initial state L.1 with the longitudinal slide in the longitudinal direction and with the lid 4 in the transverse direction 11.2, so that the loaf L is compressed in the longitudinal direction 10 into the deformed state L.2, while at the same time the lid 4 prevents the cross-section of the loaf L.2 from further increasing, especially at its thickest point.

In order to maintain the upsetting state of the loaf L.2 with such a manually pushed forward longitudinal slide 3 or longitudinal slide lid 3+4, a fixation effective in the longitudinal direction 10 must be made opposite the form tube trough 1.1.

This is possible according to FIG. 4c1 by means of several one or more notch elements 18 present, for example, along the top of the side walls 1a, b or along their outer sides in the longitudinal direction 10, in which one or more counter elements 19 of the lid 4 engage, the notch elements 18 preferably being located at the end area of the preform trough 1 remote from the longitudinal slide 3.

To push forward in the longitudinal direction 10, the longitudinal slide lid 3+4 is raised or tilted in relation to the longitudinal direction 10 to such an extent that all notch elements 18 are disengaged from all counter elements 19 and the loaf L.1 is compressed in the longitudinal direction 10 by means of the force of the operator or a spring or another force generator. In this upsetting longitudinal position, by lowering the lid 4 latching element 18 and counter-element 19 are engaged and secured in this latched position, for example by fastening elements such as the retaining clips 20 as shown in FIG. 3 or 4, or a retaining strap 17 which runs around along a transverse plane and fits closely to the preform 1.

Condition L.2 upsetting the wheel L can also be achieved and maintained by placing the longitudinal slide 3 on the front end of the push rod 8, which is secured in any longitudinal position reached by means of a self-locking thread 12 against the fixed end wall 1d through which it extends, as already described in FIG. 1a.

In that case, however, the lid 4 must be prevented from lifting both when pushed forwards and in the final state, for example by a longitudinal guide opposite the preform trough 1.1, for instance in the form of a passage 7 in the end wall 1e opposite the sliding rod 8, in which the front, free end of the lid 4 is located even when the longitudinal slide 3 is fully retracted against the end wall 1d.

FIG. 5 shows a freezer 50 in the design of a continuous freezer, through whose freezer room 51, from a feed opening 50a to a removal opening 50b, the preforms 1 with the loafs L.2 accommodated therein can be passed on several levels one above the other in the passing direction 50 on belt conveyors 54 and both can be cooled down together, preferably to such an extent that at least the outer layer of the loafs L.2 is frozen.

This is usually done by supplying cold air to freezer room 51, which is generated in the upper part of the freezer 50 and circulated in freezer room 51 by the blower 55 shown.

Within the freezer room 51, in this case the top bottom of the freezer room 51, there is no provision for freezing continuous preforms 1, but only for storing and cooling empty preforms 1, which are taken from the loading side of the freezer 50, with a loaf L.1 and can be placed in the feed opening 50a of one of the tiers for filled preforms 1, which is why the belt conveyor 54 can be moved to this uppermost tier for the stored empty preforms 1 against the passing direction 50′ of the filled preforms 1.

At each of the removal openings 50b on the removal side of the freezer 50 there shall preferably be an automatic or at least partially automatic removal device 52 for removing the frozen loafs L.2 from the preforms 1.

This consists of a support 52a, preferably flush with the top of the end of the belt conveyor 54 which pushes the preforms 1 onto this support 52a, as well as a longitudinal stop 52b for the filled preforms 1 and lateral guides for positioning in the direction of view of FIG. 5 or lift-off protections against lifting from the support 52a, which are not shown.

As a result, preform 1 is in a defined position in which an ejector 53 mounted on the support 52a can extend upwards out of the support 52a and push the frozen loaf L.2 out of the preform tub 1.1 through the ejector opening 23—after the operator has removed the lid 4.

FIGS. 6a b show a side view of a device for final pressing of the frosted loafs L.2 into a final pressed state L.3 for subsequent cutting of these loafs L:

In FIG. 6a, the channel 99, which is U-shaped in cross-section, is folded down around its front, lower end about a pivot axis running in the direction of view of FIG. 6a from the direction aligned with the longitudinal press stamp 101 and the cross press stamp 102 into a loading position which is thus open at the top, in which a frosted loaf L.2 can be inserted.

After folding up the form tube channel 99 into the working position as shown in FIG. 6b, the loaf is further pressed from the preformed, frozen state L.2 against a pressing plate in the front end area of the form tube 100 (not shown) by further insertion of the cross press stamp 102 and the longitudinal press stamp 101 until the loaf then fills the entire inner space in the form tube 100 in state L 3 and thus has the same defined cross-section over the entire length as the inner space of the form tube 100.

Then—after removal of the pressing plate not shown—the longitudinal press stamp 101 is used to move the end pressed loaf L.3 forward step by step by the desired thickness of a disc S until it stops against a stop plate 106, and the slice S is separated from the loaf L 3 immediately in front of the front end of the form tube 100 by means of a blade 107.

The slice S falls onto a first removal conveyor 103, which transports it further and transfers it to a subsequent removal conveyor 104, below which or in which there is usually a scale 105 for weighing the slices S.

LIST OF REFERENCE SIGNS

1 preform

1″ opening

1.1 preform Tub

1a, b side wall

1c bottom

1d, e fixed front wall

2 preform Cavity

3 movable front wall, longitudinal slide

3a, b sliding part

4 lid

4a limb

5 tension spring

6 edge strip, guide element

7 passage

8 push rod

9 pressure spring

10 longitudinal direction

10′ longitudinal median plane

11.1, 11.2 cross direction

12 thread

13 notch element

14 stamp appendix

15 longitudinal guide

16 guiding part

17 fastening belt

18 notch element

19 counter element

20 fastening elements, retaining clip

21 pressure spring

22 pressure spring

23 ejector opening

24 ejector plate

25 cooling fin

30 length

50 freezer

50a feed opening

50b removal opening

50′ passing direction

51 freezer room

51.1 buffer room, storage room

52 removal device

52a support

52b longitudinal stop

53 ejector

54 belt conveyor

55 blower

99 form tube channel

100 form tube

100a, b face side

101 longitudinal press stamp

102 cross-press stamp

103 removal conveyor

104 removal conveyor

105 scale

106 stop plate

107 blade

B width, distance

D diameter

Dmax maximum diameter

loaf

L.1-3 loaf, state of the loaf

Q.1-3 cross section

S slice

1.-17. (canceled)

18. A method for deforming and freezing a loaf, which is elongate in an initial state and irregular with respect to an initial cross-section along a longitudinal direction, the method comprising:
deforming the loaf to a compressed state with a cross-section which is more uniform over a length of the loaf than in the undeformed initial state; and
freezing the loaf;
wherein the loaf is compressed from the initial state before freezing with the aid of and in a preform into the compressed state, the loaf is frozen in the compressed state in the preform, and the preform in which the loaf is compressed from the initial state comprises two side walls, which are connected to each other by two end walls, one of which is fixed in the longitudinal direction.

19. The method according to claim 18, wherein after freezing, the frozen loaf is pressed out of the preform by means of an ejector.

20. The method according to claim 18, wherein the loaf is compressed from the initial state to the compressed state so that the loaf has a uniform final cross section over the length of the loaf, and wherein the loaf is compressed in the longitudinal direction by and in the preform.

21. The method according to claim 18, wherein the preform is brought to a lower temperature than that of the loaf before the introduction of the loaf into the preform.

22. The method according to claim 21, wherein the temperature to which the preform is brought before the introduction of the loaf is not more than 10° C. above the temperature during the freezing.

23. The method according to claim 18, wherein at least a length region of the loaf with a largest cross-section in at least one transverse direction in the initial state is compressed and held in the compressed state by the preform.

24. The method according to claim 18, wherein the loaf is inserted into the preform rotated about the longitudinal direction in such a rotational position that it is compressed in a transverse direction in which the loaf has its largest diameter in a region of a largest cross-section of the loaf.

25. The method according to claim 18, wherein a longitudinal region of the loaf with a largest cross-section in the initial state is compressed in two transverse directions which are transverse to each other, and is held in the compressed state by the preform.

26. The method according to claim 18, wherein at least an end of the loaf with a smaller cross-section is compressed in the longitudinal direction and held in this compressed state by the preform,
and/or
the compressing of the loaf is effected by pressing with a part of the preform which is movable in the longitudinal direction and/or in a transverse direction, wherein the movable part of the preform is fixed in the state compressing the loaf relative to the rest of the preform.

27. The method according to claim 18, further comprising removing the loaf from the preform after freezing of the loaf, wherein removal of the loaf from the preform is carried out by ejection by a moving part of the preform or by a separate ejector.

28. The method according to claim 18, further comprising a final pressing of the frozen loaf with a frozen cross-section to a final state with a final cross-section, wherein the final pressing is carried out in a circumferentially closed form tube with open end faces by longitudinal pressing and/or by transverse pressing by means of a longitudinal press stamp and/or a cross-press stamp.

29. A device for use in deforming and freezing a loaf, which is elongate in an initial state and irregular with respect to an initial cross-section along a longitudinal direction, to a state with a frost cross-section which is more uniform over a length of the loaf than in the undeformed initial state, the device comprising:
a preform for receiving the loaf;
wherein the preform is designed so that it can be subjected to a freezing process in a freezer with the loaf contained therein without suffering damage, wherein the preform includes two side walls, which are connected to each other by two end walls, one of which is positioned fixed in the longitudinal direction.

30. The device according to claim 29, further comprising an ejector that extends through an ejector-opening that extends through a bottom of the preform.

31. The device according to claim 29, wherein the preform has a variable, preform cavity that has a smaller minimum transverse expansion than a limit value, which is smaller than a smallest maximum diameter of at least 95% of the loaves to be accommodated therein in their initial state before penetration into the preform.

32. The device according to claim 29, wherein the preform has an additional end wall formed as a longitudinal slide which can be inserted between the two side walls and between the two end walls, and which can be moved in the longitudinal direction.

33. The device according to claim 32, wherein the longitudinal slide can be fixed by latching elements and counter-elements that are cooperable therewith.

34. The device according to claim 32, wherein the longitudinal slide is attached to a front end of a sliding rod which extends through the fixed end wall of the preform, and wherein the sliding rod can be screwed together with the fixed end wall by means of a self-locking thread or can be locked in different longitudinal positions by means of at least one locking element.

35. The device according to claim 29, wherein the preform comprises a preform trough that defines a form tube cavity, and a lid configured to close an upper opening of the preform trough, which lid is detachable from the preform trough or is movably attached to the preform trough, and can be fixed in one or more positions with respect to the preform trough.

36. The device according to claim 35, wherein the lid comprises a stamp appendix projecting transversely to a main plane of the lid, wherein the stamp appendix is configured to fit into the opening of the preform trough, and wherein the lid can be fixed at several height positions with respect to the preform trough.

37. The device according to claim 36, wherein at least one pressure spring is arranged between the stamp appendix and the lid.
